(19) United States
(12) Patent Application Publication
(10) Pub. No.: US 2010/0108171 A1
(43) Pub. Date: May 6, 2010

(54) PROTECTIVE SHEATH FOR CABLES, TUBES AND THE LIKE

(76) Inventors: Jordi Relats Manent, Barcelona (ES); Pere Relats Casas, Barcelona (ES)

Correspondence Address: Leason Ellis LLP, 81 Main Street, Suite 503, White Plains, NY, 10601, US

(21) Appl. No.: 12/593,315

(22) PCT Filed: Mar. 29, 2007
(86) PCT No.: PCT/ES07/00171

§ 371 Date: Sep. 28, 2009

(51) Int. Cl. F16L 9/00; H01B 17/00

(52) U.S. Cl. 138/125; 174/137 R; 138/128; 138/146

(57) ABSTRACT

Sheath which has a general tubular shape, open longitudinally, wherein the transversal cross-section is spiralled and formed by interwoven threads (11, 12); the first threads (11) are multifilament aramide fibre, with high fire resistance and low smoke emission, and the second threads (12) polyetheretherketone (PEEK) monofilament. Optionally, the cover may have a protective covering on its inner and/or outer surface.

### OBJECT OF THE INVENTION

This invention refers to a protective sheath for cables, tubes and the like, and more specifically to a sheath of the type that has an appreciably tubular, longitudinally open arrangement, having a transverse section in the form of a spiral.

### BACKGROUND TO THE INVENTION

Currently it is a usual practice to use protective sheaths for the bunching together and covering of lengthy elements such as bunches of cables, tubes and the like.

In addition to allowing elements that go through the inside to be bunched together these sheaths, especially when dealing with bundles of cables, have the further purpose of absorption that appreciably reduces the noises produced by the banging of these elements against other parts. These sheaths, depending on their make up or constitution, provide mechanical protection to the elements placed on the inside, preventing them from rubbing against other parts and thermal protection or insulation that prevents the accelerated deterioration of the cables or tubes that go through the inside of the sheath when said elements are close to a heat source.

Currently differing protective tubes or sheaths are known about from differing registration precedents that fulfill the previously stated functions to a greater or lesser degree, in each case depending on the level of protection of the constitutive materials of the sheath in question.

The applicant of this invention is the holder, amongst others, of the following utility models: 9103120, 200102124, and the patent invention 200100557.

Said registration precedents make reference to protective tubes or sheaths that are made up from a plurality of differing threads that are woven or braided together and which provide the sheath, depending on their composition, with differing mechanical resistance, thermal insulation and acoustic insulation characteristics.

Specifically in utility model 200103120 the tube or sheath or protection is made up first of some polyamide mono-filament threads and secondly of textured polyamide multi-filament threads, the outside of the tube having a protective coating of silicone resin.

In the utility model 200103124 the protective tube or sheath is made up of some glass threads or quartz threads.

In the invention patent 200100557 the protective tube is made up first of some polyamide mono-filament threads, second of some multi-filament threads of textured polyester and third some polyamide or polyester mono-filament threads.

Another existing registration precedent is constituted by the European patent, with publication number 0.472.661, that refers to a sound absorbent sheath made from a woven fabric having first and second interwoven threads, both being able to be made of polyester, or one of them of polypropylene and the other of a polyester mono-filament.

The stated precedents provide the cables, tubes or elements that run through the inside of the sheath with insufficient protection and do not fulfill the current demands for their safe application in specific industries, such as aeronautics.

Therefore, the technical problem that is posed is the obtaining of a sheath that has high resistance to fire and provides low smoke emission on being subjected to direct flame, in spite of this retaining good acoustic insulation and a high degree of mechanical resistance to wear.

### DESCRIPTION OF THE INVENTION

The protective sheath for cables, tubes and the like, object of this present invention, is of the type which has a generally tubular arrangement, are longitudinally open and which are made up of threads woven in a knitting machine, it has some constructive characteristics aimed at solving the previously stated problems, giving high resistance to fire, low smoke emission in the case of being subjected to direct flame, good mechanical resistance and a high level of acoustic insulation.

In order to do this, and in accordance with the invention, the constitutive fabric of the protective sheath is made up first of some multi-filament aramide fibre threads that are highly resistant to fire and have low smoke emission, and second some mono-filament poly-ether-ether-ketone (PEEK) threads.

The first multi-filament aramide fibre threads and the second mono-filament polyester threads are woven together, making up the longitudinally open tubular body of the sheath.

Optionally, the sheath has a resin protective coating on the inside and/or outside, such as a silicone, acrylic or polyurethane plastic resin.

Owing to the high cost of the stated multi-filament aramide fibre threads, it has been provisioned that these can form part of the sheath in a variable proportion, depending on the degree of fire resistance that it is required to reach, which on the other hand will be determined by the requirements demanded in the field of application that the sheath is aimed at.

### DESCRIPTION OF THE FIGURES

In order to complete the description that is being made and for the purpose of providing a better understanding of its characteristics, a set of drawings is attached to this present description in which the figures being by way of illustration and are not by way of limitation on the invention, in which the following is shown:

FIG. 1 shows a perspective view of an example of an embodiment of the protective sheath of the invention.

FIG. 2 shows a diagrammatic view of a transversal section of the sheath shown in the preceding figure, made up solely of a fabric made from a base of multi-filament aramide fibre threads and mono-filament polyester threads.

FIG. 3 shows a variation of the embodiment of the protective sheath, with a silicone resin protective coating on its external face.

### PREFERRED EMBODIMENT OF THE INVENTION

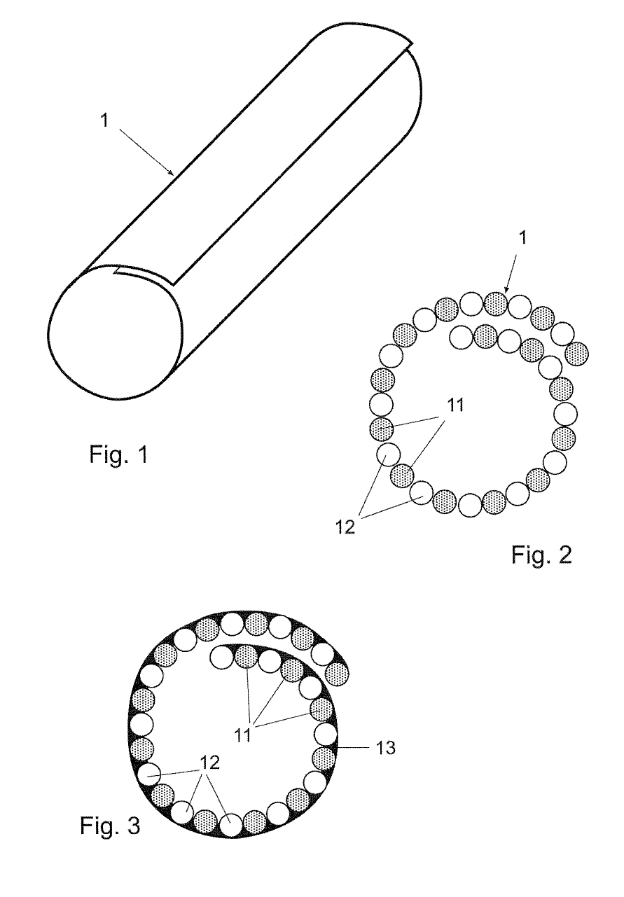

In the example of the embodiment shown in FIGS. 1 and 2, the protective sheath, referenced in its entirety as (1), has a longitudinally open tubular arrangement so as to make the arrangement around the cables, tubes or elements to be protected easier.

Said sheath is made up of a fabric manufactured in a knitting machine and made first from some multi-filament aramide fibre threads (11) and second from some mono-filament polyester threads (12).

In the example of the embodiment shown in FIG. 2, the sheath has a silicone resin protective coating (13) on the outer surface.

Once having sufficiently described the nature of the invention, likewise having given a preferred embodiment it is placed on record that the materials, shape, size and arrangement of the elements described can be modified provided that they do not mean an alteration of the basic essentials of the invention that are claimed below.

1. Protective sheath for cables, tubes and the like which has a general longitudinally open tubular shape, that has a transversal cross-section which is a spiral and formed by interwoven threads (11, 12); characterised in that the fabric first has some multifilament aramide fibre threads (11), with high fire resistance and low smoke emission, and some second polyetheretherketone (PEEK) monofilament threads (12).

2. A protective sheath according to claim 1, characterised in that the cover has a protective coating on its inner and/or outer surface (13).

3. A protective sheath according to claim 2, characterised in that the protective coating (13) is a silicone, acrylic or polyurethane plastic resin.
